(19) United States
(12) Patent Application Publication
(10) Pub. No.: US 2003/0161153 A1
(43) Pub. Date: Aug. 28, 2003

(54) Ceiling lighting fixture assembly

(76) Inventor: Anthony G. Patti, Arcadia, CA (US)

Correspondence Address: Marvin H. Kleinberg, Suite 1080, 2049 Century Park East, Los Angeles, CA, 90067, US

(21) Appl. No.: 10/352,400

(22) Filed: Jan. 28, 2003

Related U.S. Application Data
(60) Provisional application No. 60/360,456, filed on Feb. 28, 2002.

(51) Int. Cl. F21V 21/28

(52) U.S. Cl. 362/289; 362/275; 362/372; 362/428

(57) ABSTRACT

An improved recessed lighting fixture allowing illumination from a lighting unit placed within a cavity of a planar surface, such as a ceiling or wall. The invention facilitates the ability to properly aim illumination because the user can aim the fixture while it is in place and illuminated. The invention is additionally designed to allow the substitution of lamps/light bulbs without requiring re-aiming of the fixture and to be used without modification with ceiling materials of varying thickness. The invention also includes an azimuthal adjustment mechanism wherein the lamp is mounted on a gimbal having a rack and pinion coupling to rotate the gimbal under control of a screw accessible from the exterior of the fixture and a horizontal aiming system.

This application is a continuation-in-part of a U.S. application filed on Feb. 28, 2002 and having Ser. No. 60/360,456.

### BACKGROUND

1. Field of the Invention

The present invention relates generally to lighting fixtures and, more specifically, to an improved in-ceiling lighting fixture.

2. Prior Art

Recessed lighting fixtures are well known in prior art. However, such fixtures have been visually obtrusive in that all or some portion of the fixture falls below the ceiling line and disrupts the plane of the ceiling. Recently, low voltage halogen lights have become more popular because they are brighter and consume less energy. This has led to a need for further improvements in recessed lighting fixture design.

For aesthetic reasons, an in-ceiling light fixture is normally at least partially recessed into the planar surface of the ceiling. An opening is cut into the ceiling to illuminate the area beneath the light fixture. The fixture is generally mounted into the ceiling such that the bottom of the fixture (that part closest to the floor when installed) does not extend beyond the plane of the ceiling. Because the opening in the ceiling does not generally have a finished appearance, a trim or bezel is generally installed in the opening to enhance its appearance and conceal the cut out. Historically, the trim piece has been below the planar surface of the ceiling, visually diminishing the aesthetics of the ceiling. The same situation exists with wall mounted recessed lighting.

Another problem arising from the fixtures of prior art is that they could not accommodate differing thickness in ceiling materials. Ceiling panels are constructed in varying thickness and the trim/bezel must accommodate the multiple sizes of the ceiling material that are currently available in the market. Formerly, this required the manufacture and use of multiply sized trim kits and increased the costs of storage, materials and labor in installing recessed lighting.

Additionally, the light within the fixture must be properly aimed to achieve the desired design and aesthetic effect and such fixtures have been difficult and time-consuming to aim properly. Traditionally, aiming the light required the user to first turn on the light to see where it is initially aimed, then turn off the light to let it cool down (as is required with halogen lighting), then adjust the aim of the light and then turn it on again to see where it is aimed after the adjustment. The process must be repeated until the light is aimed at the desired location. Thus, in the prior art, lights have been difficult to aim without generally requiring several iterations of aiming and adjusting the light, with a cool-down period between each of the several iterations.

Additionally, the light bulbs within the fixtures have been difficult to replace without removing at least part of the fixture. Moreover, after removing the fixture, the aim of the light is often altered and requires re-adjustment and re-aiming of the fixture after the light bulb has been replaced.

Therefore, what is needed is an in-ceiling or recessed lighting fixture that is east to install and use, easy to aim and facilitates bulb replacement without requiring re-aiming of the fixture.

### BRIEF SUMMARY OF THE INVENTION

According to the present invention, an improved recessed lighting fixture allows aesthetically pleasing illumination from a lighting unit placed within a cavity of a planar surface, such as a ceiling or wall. The invention facilitates the ability to properly aim the lamp because the user can aim the fixture while it is in place and illuminated. It also allows the substitution of lamps/light bulbs without requiring re-aiming of the fixture. Additionally, the present invention may be used without modification with ceiling materials of varying thickness. The housing also includes an azimuthal adjustment mechanism. The lamp is mounted on a gimbal having a rack and pinion coupling to rotate the gimbal under control of a screw accessible from the exterior of the fixture.

The basic elements of the invention include: a housing unit designed to fit into a structure (such as a ceiling or wall), a light source that illuminates an area (such as below a ceiling), electrical wiring from a power source to the housing unit, a lamp/light socket, a holder for the light socket, means to adjust the holder to aim a light placed in the light socket, a light bulb, means to easily replace the light bulb without removing the housing and a trim ring that provides a finished look to the housing unit when viewed from the area to be illuminated.

Unlike prior art, the current invention contains means to aim the lamp while it is on, without the need to turn the lamp off and to allow it to cool down. Additionally, the lamp has a holder that allows rapid changing of the lamp without interfering with lamp aiming and without the need to disassemble the housing unit.

It is therefore an object of the invention to provide a lighting system designed to fit into a recessed space, such as in a ceiling. To be architecturally and aesthetically pleasing, the light must be strong enough to provide adequate illumination, but diffuse enough to prevent glare or harsh lighting. Thus, the light must be aimable to allow for the proper lighting pattern for conditions within the area to be lit. As with any lighting system, light bulbs ultimately burn out and require replacement. In a recessed lighting system, the bulb should not require readjustment to obtain the correct aim after replacing the bulb.

It is a further object of the present invention to provide a trimless and recessed lighting fixture that has a light that can be easily aimed by a unique frictional clutch assembly.

It is a further object of the present invention to incorporate a trim ring into said lighting assembly that is easily capable of adjusting to allow for installation into surfaces having various sizes (thickness).

It is a further object of the present invention to provide a method for a unique trim alignment tab and mating key slotted lockable rotation ring that allows for easy and repetitive replacement of fixture trims.

It is a further object of the present invention to provide a method to quickly replace a bulb without changing the original lamp aiming angle and position.

Further features and advantages of the present invention will be appreciated by reviewing the following drawings and detailed description.

### BRIEF DESCRIPTION OF THE DRAWINGS

For a further understanding of the objects and advantages of the present invention, reference should be had to the following detailed description, taken in conjunction with the accompanying drawing, in which like parts are given like reference numbers and wherein:

FIG. 1 is a side section, cutaway view of the recessed ceiling light housing fixture;

FIG. 2 is a back elevation view of the azimuthal aiming bracket within the recessed ceiling light housing fixture of FIG. 1;

FIG. 3 is a side section view of;

FIG. 4a is a side section view of the rack and pinion lamp adjustment and aiming mechanism and the gearing assembly of the azimuthal aiming mechanism of FIG. 2;

FIG. 4b is a top section view of the rack and pinion lamp adjustment and aiming mechanism and the gearing assembly of the azimuthal aiming mechanism of FIG. 2;

FIG. 5 is a side section, cutaway view of the recessed ceiling light housing fixture and a trim ring;

FIG. 6 is a side section view of the cutaway view of the fixture of FIG. 5 along line 6-6 in the direction of the appended arrows;

FIG. 7 is a bottom view of the circular trim ring of FIG. 5;

FIG. 8 is a side section view of the trim ring of FIG. 7, taken along line 8-8 in the direction of the appended arrows;

FIG. 9 is a bottom view of a square trim ring according to the present invention;

FIG. 10 is a side view of the trim ring of FIG. 9 along the line 10-10 in the direction of the appended arrows;

### DETAILED DESCRIPTION OF THE INVENTION

In the following description, for the purposes of explanation, specific component arrangements and constructions and other details are set forth in order to provide a more thorough understanding of the present invention. It will be apparent to those skilled in the art that the present invention may be practiced without these specific details. In some instances, well-known manufacturing methods and structures have not been described in detail to avoid unnecessarily obscuring the present invention.

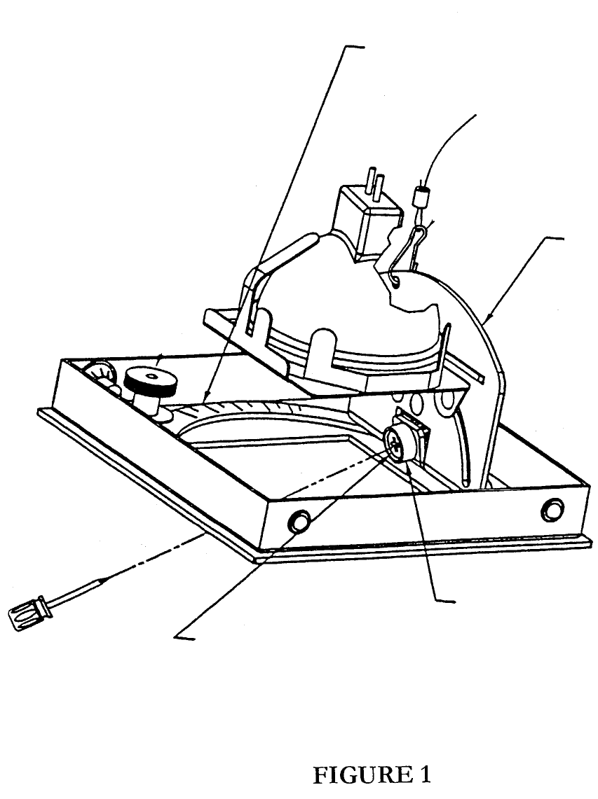

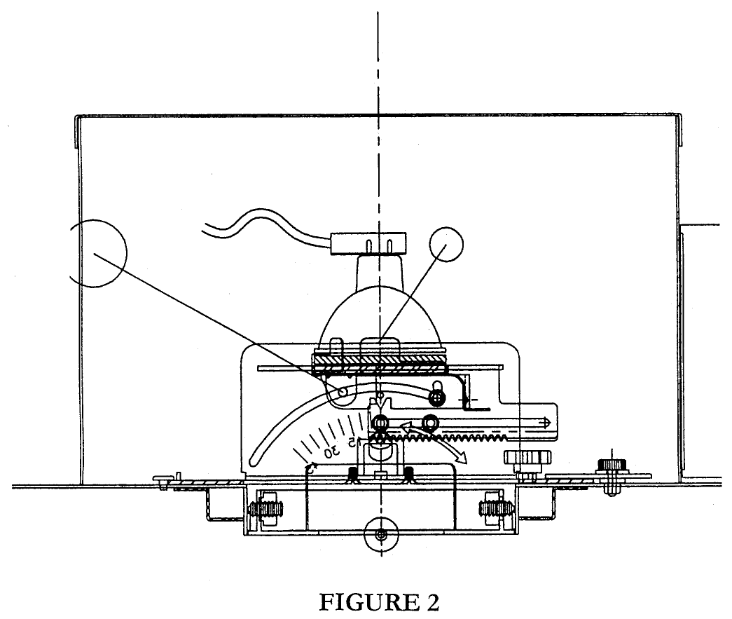

Referring first to FIG. 1, a perspective view of the lamp housing unit 10 of the present invention is shown. FIG. 2 presents a cut away side section view of the housing unit 10. Contained within the housing unit 10 is a lamp support system 14 that includes a lamp socket 16, an azimuthal light aiming mechanism 18, an angular light aiming system 19 and a light bulb/lamp 20. Optionally, a transformer 12 (for low voltage operation) is coupled with the housing unit 10.

The housing unit 10 of the preferred embodiment is designed for installation in a cavity behind a planar surface, such as a wall or ceiling. The housing unit 10 may include a cylindrically shaped baffle 22 that helps direct light towards the area to be illuminated.

Installation of the housing unit 10 requires an opening 24 in the planar surface to allow illumination from the housing unit 10 into a room or other area. The opening 24 will initially have an unfinished appearance and the baffle 22 of the housing unit 10 extends into the opening to provide a more finished appearance. Coupled to the baffle 22 is a mud/plaster ring 25. Coupled to the mud ring 25 is a trim ring 26 that provides a finished appearance to the installed fixture.

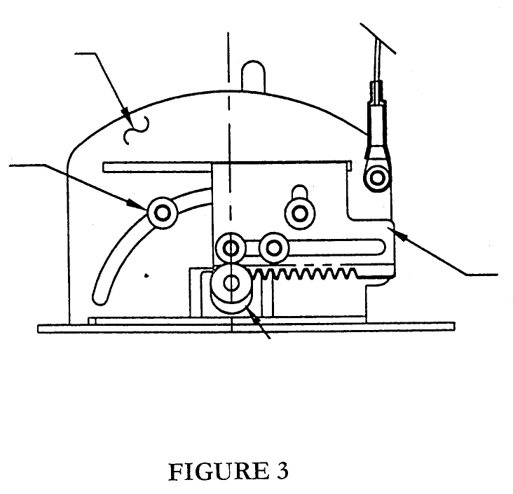

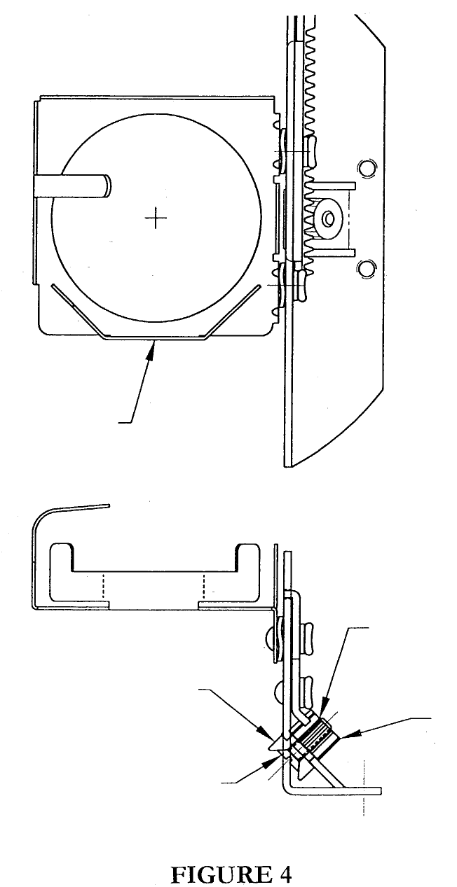

Referring next also to FIGS. 3 and 4, a detailed view of the means to aim the lamp/light bulb 20 is shown. The lamp 20 can be azimuthally adjusted through an arc angled from 0 to 45 degrees. The angle of illumination is adjustable, even while the lamp is on and/or hot, by means of a unique rack and pinion gear assembly 28 and screw adjustment assembly 30 (FIG. 1).

The lamp aiming assembly 14 includes of a bracket 32 having a banana slide opening 34, a rack and pinion assembly 28, an adjustment screw 36, and a lamp holder 14 coupled to the bracket 32 (best seen in FIG. 1). When fully assembled, the lamp assembly can rotate about a horizontal axis as much as 45 degrees from vertical. The rack and pinion assembly 28, attached to the bracket 32, includes a series of teeth 40 at its bottom edge, a rectangular opening 42 running parallel to the planar surface of the mud ring 26 and two holes 44 that allow the lamp holder 14 to be coupled to the rack and pinion assembly 28 and the bracket 32.

Referring now to FIGS. 3 and 4, as noted above, the bracket 32 is affixed perpendicularly to the housing trim 38 and has a front surface 46 located nearest the light opening 24 and a back surface 48. A positioning screw 36 and pinion gear 30 are located at the base of the bracket 32. The screw 36 head is located towards the light opening 24 such that the screw 36 can be turned with a screwdriver 37 and accessed from the light opening 24.

The rack and pinion assembly 28 is located at the back surface 48 of the bracket 32. The lamp holder 14 is located adjacent to the front bracket surface 46 of the bracket 32 and is coupled to the rack and pinion assembly 28 by two rivets or screws affixed to each of the two holes 44 of the rack and pinion assembly 28. At least one of the two holes 44 is elongated perpendicularly to the base of the trim 38. When installed, the two lamp holder screws pass through the banana shaped arc opening 34 of the bracket 32 and the rack and pinion assembly 28.

Rotating the screw 36 with a screwdriver 37 (FIG. 1) causes the pinion gear 30 to rotate. Because the gear 30 engages the teeth 40 of the rack 28, rotating the gear 30 causes translation of the rack 28 roughly parallel to the planar surface of the trim 38. Because the lamp holder 14 is connected to the rack and pinion assembly 28 through the banana shaped opening 34, the lateral movement of the rack and pinion assembly 28 causes the lamp holder 14 to move in a direction that follows the curvature of the banana shaped opening 34. The movement of the lamp holder 14 causes the light/lamp 20 to pivot about a horizontal axis along the path of the banana shaped opening and allows it to be aimed from 0 degrees to 45 degrees relative to the bracket 32. In this manner, the light can be aimed, even while it is on and hot, using only a screwdriver.

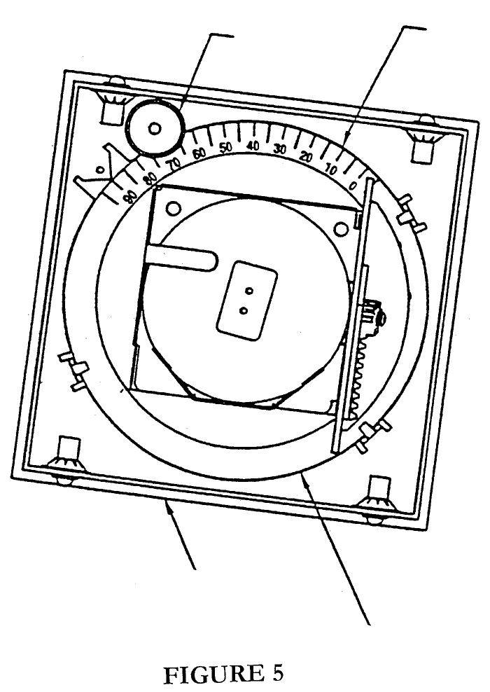

Referring next to FIG. 5, in addition to angular aiming described above, the light can be adjusted in azimuth through rotation of the trim. To adjust the light about a vertical axis in a square trim 52 fixture, the trim is rotated about a vertical axis in 90-degree increments. This allows the illumination to be directed towards any of the four generic compass directions. After being set in one of these four general directions, the rotational aim can be further adjusted 45 degrees in either direction using a unique azimuthal aiming system.

The horizontal aiming system includes a circular track 60, track tabs 62 and a setscrew 36 mounted on the track. When the setscrew 36 is loosened, the track 60 may rotate 45 degrees in either direction from a central index point. Thus, within each 90-degree direction available from rotating the trim 38, incremental rotation is available such that the combined rotational movement allows for a full 360 degrees of rotation. When the desired horizontal direction of illumination is achieved, the setscrew 36 can be tightened to prevent further rotational movement of the track 54.

When a circular trim unit 26 is used, the aiming system can permit a complete 360-degree rotation without the need for an adjustment track.

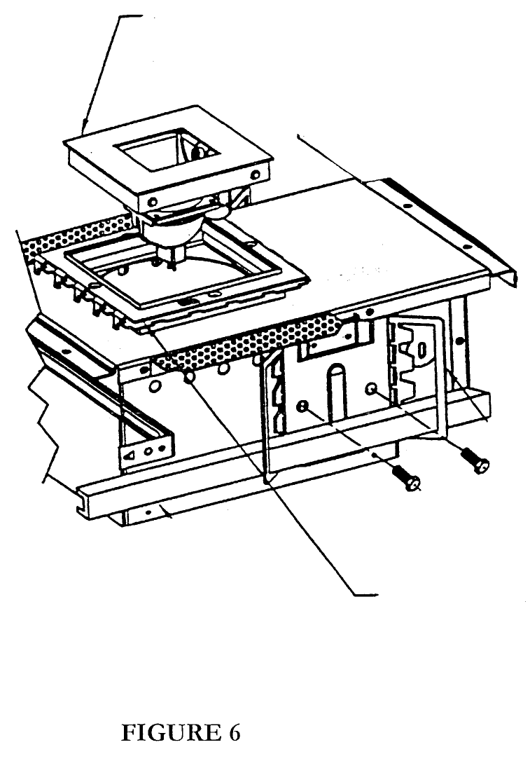

Referring next to FIG. 6, coupled to the housing unit 10 is a mud ring 25. The mud ring 25 couples to a trim ring 26. One purpose of the trim 26 is to provide a finished look to the illumination opening in a way that allows the trim 26 to accommodate varying ranges of ceiling thickness. Common ceiling materials are standardized at a thickness of ½″, ⅝″, ¾″ or 1″. A trim ring 26 that is too shallow will leave the illumination opening 24 partially uncovered while a trim ring 26 that is too deep extends beyond the opening 24. Either situation defeats the goal of having an architecturally pleasing ceiling.

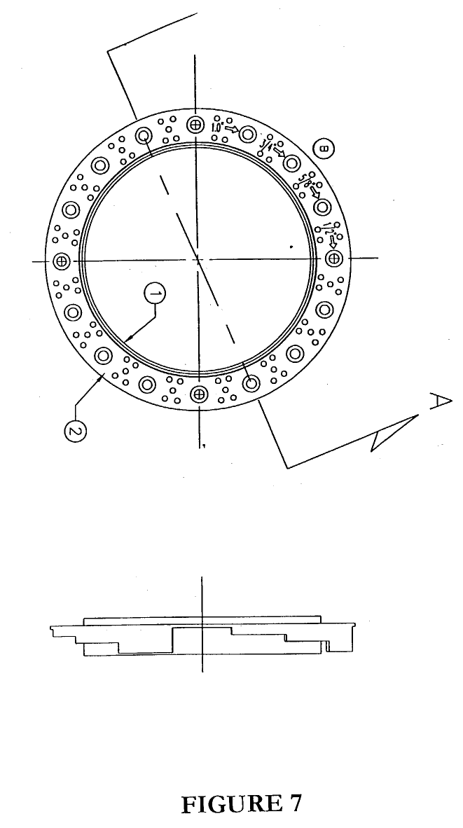

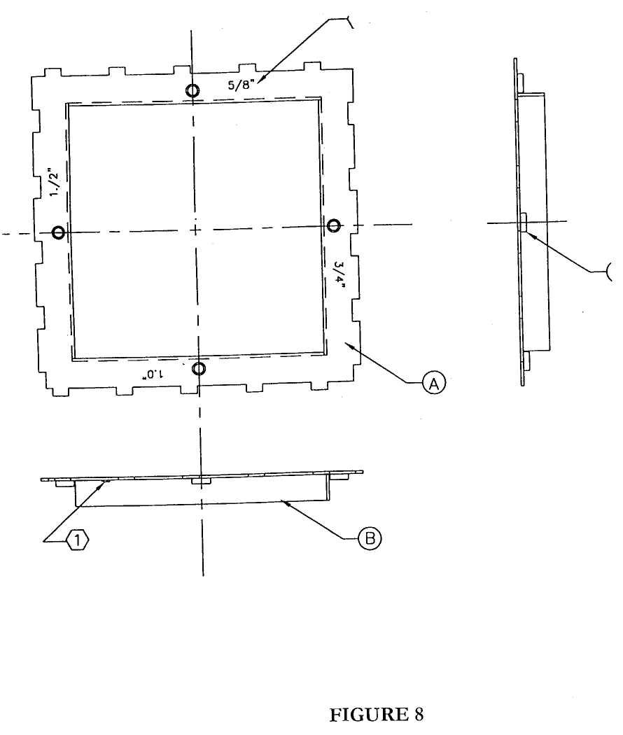

Referring now to FIGS. 7, 8 16 and 17, ceilings of varying thicknesses are accommodated via a novel series of alignment tabs located both on the housing baffle 22 (baffle slots 70) and on the trim ring 26 (trim ring tabs 72). The trim ring tabs 72 are of various lengths such that the shortest such tab 72 allows for use in a ½″ ceiling. The longest tab 72 allows for use in a 1″ ceiling. The baffle slots 70 serve as the base and align with matching levels of staircase type tabs 72 of the trim ring 26. Because the trim ring tabs 72 are stepped, i.e. of varying lengths to match different ceiling thickness, the trim ring 26 can be varyingly spaced in relation to the housing 10 to accommodate multiple ceiling thickness by rotating the ring to the appropriate tab position for the ceiling thickness of the specific installation. When the baffle tabs 70 and trim ring tabs 72 properly align for the appropriate ceiling thickness, the trim ring 26 connects to the baffle 22 through a set of screws (not shown) or other devices.

The square trim ring 26, shown in FIG. 17, works in much the same way as the round trim ring 26. The trim ring 26 has trim ring tabs 72 to allow the trim ring 26 to properly align for ceiling thickness. Each side of the square baffle 22 has tabs 70 that are coordinated to align with the trim ring tabs 72 for a specific ceiling thickness. By way of example, the tabs 70 of the first edge of the baffle 22 may align with the trim ring tabs 72 for a 1″ ceiling tile. The baffle tabs 70 of the next side might may align with the trim ring tabs 72 for a 1″ ceiling tile.

In this manner, the baffle 22 of the housing unit 10 can be extended or shortened, as necessary, through the stepped trim tabs 70 and 72. When the trim 34 is at the proper depth for the ceiling thickness, plaster can be smoothly applied from the planar surface up to the inner edge of the mud ring 25. The trim ring 26 is then affixed to the housing unit 10 and is flush with the planar surface, to provide a finished look to the installed fixture.

As noted above, the trim pieces come in a variety of shapes with the most predominant shapes being round and square. Round trim pieces employ a unique method of ensuring that the lamp will remain properly aimed, even if lamp/light bulbs are replaced.

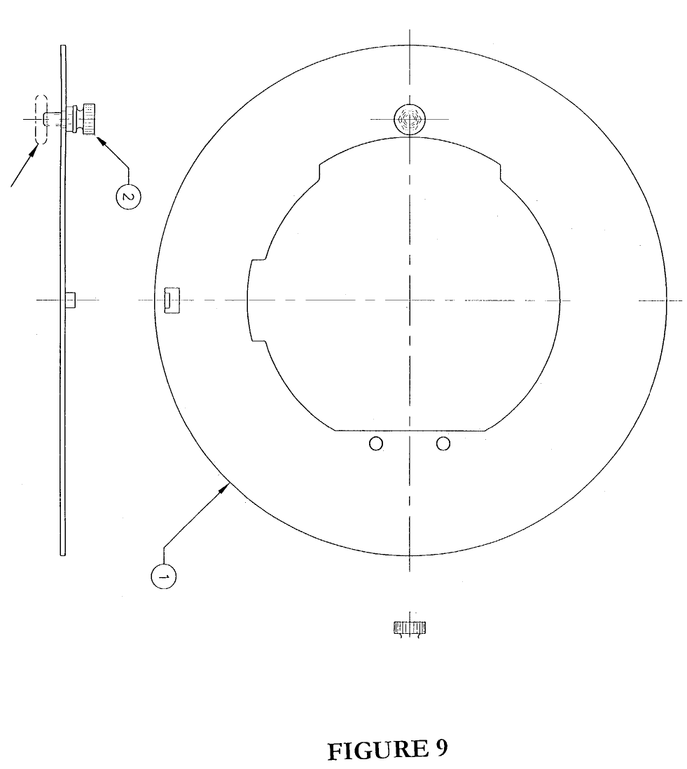

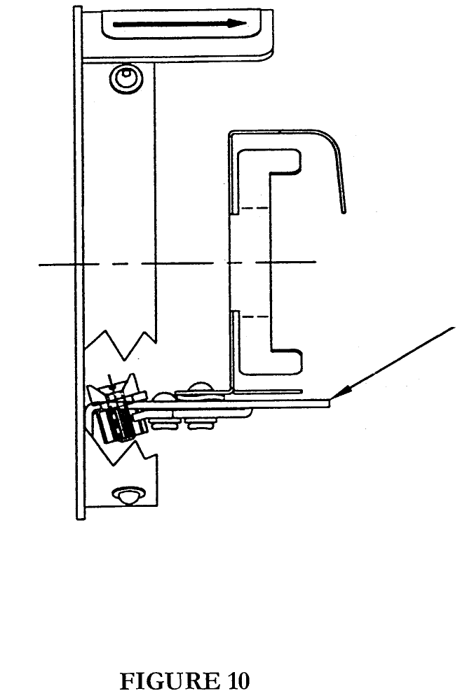

Referring next to FIGS. 9-10, the invention incorporates a unique trim alignment tab 74, coupled to the trim ring 38, and a mating key slotted lockable rotation ring 76 coupled to the light housing fixture 10. This allows for repetitive replacement of fixture trims after re-lamping or lamp adjustment while still maintaining the original lamp aiming setting. The slot 78 of the ring 76 is sized to receive the trim alignment tab 74. Using the slot 78 of the ring 76 as a guide, there is only one way for the alignment tab 74 to fit into the light housing fixture 10. Because the aiming mechanism 18 is independent of the trim replacement process, replacing the trim 26 will not disturb the aim of the light bulb.

The invention as described above can be produced in different embodiments. In one embodiment, known as a trim based system, the lamp aiming system 18 is coupled to the trim ring 26. In another embodiment, known as a housing based system, the lamp aiming system 18 is coupled to the housing unit 10. The housing and the trim based systems offer the same features as previously described. However, the housing based system additionally offers an extremely easy means to replace a lamp/light bulb 20 within the fixture.

The description of the present invention has been made with respect to specific arrangements and constructions of recessed, trimless architectural lighting fixture. It will be apparent to those skilled in the art that the foregoing description is for illustrative purposes only, and that various changes and modifications can be made to the present invention without departing from the overall spirit and scope of the present invention. The full extent of the present invention is defined and limited only by the following claims.

What is claimed is:

1. A recessed trimless lighting fixture, comprising:
a housing unit;
a power source coupled to said housing unit;
a lamp support system coupled to, and within, said housing unit comprising:
a lamp socket;
means to hold said lamp socket;
a lamp aiming mechanism capable of being adjusted while said power is being supplied to said housing unit; and
a trim ring capable of being adjusted for use with various surfaces thicknesses and coupled to said housing unit.

2. The device of claim one wherein said housing unit additionally comprises a rectangular box, having:
a circular opening on one surface of said box;
a cylindrical baffle extending away from said circular opening;
said baffle having a first edge proximately coupled to said housing unit and a second edge distal from said housing unit; and
a plurality of tabs extending radially outward from said second edge.

3. The invention of claim 1 wherein said lamp aiming system additionally comprises:
an azimuthal light aiming mechanism; and
a horizontal light aiming mechanism.

4. The invention of claim 1 additionally comprising a transformer coupled to said housing unit.

5. The invention of claim 1 wherein said lamp support system is coupled to said housing unit.

6. The invention of claim 1 wherein said lamp support system is coupled to said housing trim.

7. The invention of claim 1 wherein said trim ring is circular.

8. The invention of claim 1 wherein said trim ring is rectangular.

9. The invention of claim 2 wherein said plurality of tabs comprises:
a second plurality of sets of tabs;
each tab in any single said set of tabs being of the same length as each other said tab in the same said set;
each said set of tabs comprised of a plurality of tabs that are different in length from tabs in any other set of said plurality;
each tab within each said set being spaced to couple to said housing unit such that the elevation of the planar surface of said trim rim, relative to said housing unit, is dependent upon the said set of tabs coupled to said housing unit; and
wherein said pluralities of tabs may be used to enable said trim rim to be flush, on its visible side when installed, to the surface into which said housing unit is recessed, regardless of the thickness of said surface.

10. The invention of claim 3 wherein said azimuthal aiming mechanism comprises;
a bracket having a banana slide opening and affixed perpendicularly to said housing trim, including;
a front surface located proximate to a light opening in said housing trim and a back surface located distal from said light opening;
a positioning/adjustment screw and gear coupled to a base of said bracket;
said screw having a head located proximate to said light opening such that said screw can be turned with a screwdriver and accessed from said light opening.
a rack and pinion assembly located at said back surface of said bracket, including;
a series of teeth in said rack and pinion assembly's bottom edge;
said teeth pointed down towards and engaged by a gear coupled to said bracket;
a rectangular opening parallel to a planar surface of said mud ring;
two holes to allow a lamp holder to be coupled to said rack and pinion assembly and to said bracket;
said lamp holder located adjacent to said front bracket surface of said bracket and coupled to said bracket and to said rack and pinion assembly by two rivets or screws affixed to each of said two holes of said rack and pinion assembly; and
a lamp coupled to said lamp holder;
wherein, when fully assembled, said lamp assembly can move up to 45 degrees in an arc corresponding to the curvature of said banana slide opening.

11. The invention of claim 3 wherein said horizontal aiming mechanism comprises:
a circular track coupled to said housing unit;
track tabs coupled to said circular track;
a setscrew coupled to said track tabs; and
a lamp holder mounted on said track;
wherein when said setscrew is loosened, the track may rotate 45 degrees in either direction and said lamp aiming system may be set into said housing unit in each of four 90-degree directions by rotating said trim.

12. A recessed trimless lighting fixture, comprising:
a housing unit including a rectangular box comprising:
a circular opening on one surface of said box;
a cylindrical baffle extending away from said circular opening;
said baffle having a first edge proximately coupled to said housing unit and a second edge distal from said housing unit;
a first plurality of tabs extending radially outward from said second edge, including;
a plurality of sets of tabs;
each tab in any single said set of tabs being of the same length as each other tab in the same said set;
each said set of tabs comprised of a plurality of tabs that are different in length from tabs in any other set of said plurality;
each tab within each said set being spaced to couple to said housing unit such that the elevation of the planar surface of said trim rim, relative to said housing unit, is dependent upon the said set of tabs coupled to said housing unit a plurality of sets of tabs; and
whereby said pluralities of tabs may be used to enable said trim rim to be flush, on its visible side when installed, to the surface into which said housing unit is recessed, regardless of the thickness of said surface.
means to connect said housing unit to a power source;
a lamp support system within said housing unit comprising:
a lamp socket;
means to hold said lamp socket;
a lamp aiming mechanism capable of being adjusted while said power is being supplied to said housing unit, including;
an azimuthal aiming mechanism, including;
a bracket having a banana slide opening and affixed perpendicularly to said housing trim, including;
a front surface located nearest a light opening in said housing trim and a back surface located away from said light opening;
a positioning/adjustment screw and gear coupled to a base of said bracket;
said screw having a head located towards said light opening such that said screw can be turned with a screwdriver and accessed from said light opening.
a rack and pinion assembly located at said back surface of said bracket, including;
a series of teeth in said rack and pinion assembly's bottom edge;
said teeth pointed down towards and engaged by a gear coupled to said bracket;
a rectangular opening running parallel to a planar surface of said mud ring;
two holes that allow a lamp holder to be coupled to said rack and pinion assembly and to said bracket;
said lamp holder located adjacent to said front bracket surface of said bracket and coupled to said bracket and to said rack and pinion assembly by two rivets or screws affixed to each of said two holes of said rack and pinion assembly;
whereby, when fully assembled, said lamp assembly can move up to 45 degrees in an arc corresponding to the curvature of said banana slide opening;
a trim ring capable of being coupled to said housing unit; and
a horizontal aiming system, including;
a circular track coupled to said housing unit;
track tabs coupled to said circular track;
a setscrew coupled to said track tabs; and
a lamp holder mounted on said track;
wherein when said setscrew 36 is loosened, the track may rotate 45 degrees in either direction and wherein said lamp aiming system may be set into said housing unit in each of four 90-degree directions by rotating said trim.
